(19) United States
(12) Patent Application Publication
(10) Pub. No.: US 2019/0376591 A1
(43) Pub. Date: Dec. 12, 2019

(54) FLUID TRANSMISSION DEVICE

(71) Applicant: AISIN AW CO., LTD., Anjo-shi, Aichi-ken (JP)

(72) Inventors: Kazuyoshi ITO, Tsushima (JP); Hiromitsu TAKENAKA, Anjo (JP); Makoto NAKAZURU, Inazawa (JP); Mayuko KAWADA, Anjo (JP)

(73) Assignee: AISIN AW CO., LTD., Anjo-shi, Aichi-ken (JP)

(21) Appl. No.: 16/473,548

(22) PCT Filed: Mar. 27, 2018
(86) PCT No.: PCT/JP2018/012509

§ 371 Date: Jun. 25, 2019

(30) Foreign Application Priority Data
Mar. 27, 2017 (JP) 2017-060372

(51) Int. Cl. F16H 45/02; F16H 41/24

(52) U.S. Cl. CPC F16H 45/02; F16H 2045/0221; F16H 2045/0289; F16H 41/24

(57) ABSTRACT

A fluid transmission device that includes a pump impeller connected to an input; a turbine runner disposed so as to face the pump impeller; an output coupled to the turbine runner; and a lockup clutch device configured to execute lockup in which the input and the output are coupled and lockup release in which the coupling of the input and the output is disconnected, the pump impeller, the turbine runner, the output, and the lockup clutch device being provided in the input.

### BACKGROUND

The description relates to a fluid transmission device.

There has hitherto been proposed a torque converter including a pump impeller that has an outer shell welded to a front cover, a turbine runner that has a turbine shell disposed so as to face the outer shell, a turbine shaft that is fitted to a turbine hub joined with the turbine shell, and a lockup clutch mechanism that has first and second lockup clutches disposed side by side in an axial direction of the turbine shaft (see JP 2016-142404 A, for example). In the lockup clutch mechanism, the first lockup clutch has a first lockup disk that is slidably supported by a clutch hub fitted to the turbine shaft. A first friction plate (friction material) is fixed to the first lockup disk so as to face an engagement surface that is formed on an inner surface of the front cover. The second lockup clutch has a second lockup disk that is slidably supported by the turbine hub. A second friction plate (friction material) is fixed to the second lockup disk so as to face the engagement surface via the first friction plate. Thus, in the lockup clutch mechanism, the first and second friction plates are engaged with the engagement surface of the front cover in an overlapping manner. As another form of the lockup clutch mechanism, the first and second friction plates are disposed side by side in a radial direction of the turbine shaft and are able to be individually engaged with the engagement surface of the front cover.

### SUMMARY

However, in the lockup clutch mechanism of the former form, the first lockup clutch and the second lockup clutch are connected in series with respect to the front cover and the turbine shaft. Thus, there are cases in which torque capacity is not sufficient. In contrast, in the lockup clutch mechanism of the latter form, the first lockup clutch and the second lockup clutch are connected in parallel with respect to the front cover and the turbine shaft and thus, sufficient torque capacity is able to be ensured. However, the size of the front cover etc. is increased in the radial direction since the two friction plates (friction materials) are disposed side by side in the radial direction.

An exemplary aspect of the disclosure improves torque capacity of a lockup clutch and suppress an increase in size of the device.

The fluid transmission device of the disclosure is a fluid transmission device that includes: a pump impeller connected to an input, a turbine runner disposed so as to face the pump impeller; an output coupled to the turbine runner; and a lockup clutch device configured to execute lockup in which the input and the output are coupled and lockup release in which the coupling of the input and the output is disconnected, the pump impeller, the turbine runner, the output, and the lockup clutch device being provided in the input. The input has a first engagement surface and a second engagement surface that face each other with the lockup clutch device interposed between the first engagement surface and the second engagement surface in an axial direction. The lockup clutch device has a first lockup clutch that includes a first lockup piston in which a friction material is affixed to a surface that faces the first engagement surface, and a second lockup clutch that includes a second lockup piston in which a friction material is affixed to a surface that faces a second engagement surface. The lockup clutch device executes lockup by supplying working oil between the first lockup piston and the second lockup piston so that the first lockup piston and the second lockup piston are spaced away from each other in the axial direction.

The fluid transmission device of the disclosure includes the pump impeller, the turbine runner, the output, and the lockup clutch device, which are provided in the input. The input has the first engagement surface and the second engagement surface that face each other with the lockup clutch device interposed between the first engagement surface and the second engagement surface in the axial direction. The lockup clutch device has the first lockup piston in which the friction material is affixed to the surface that faces the first engagement surface, and the second lockup piston in which the friction material is affixed to the surface that faces the second engagement surface. The lockup clutch device then performs lockup by supplying working oil between the first lockup piston and the second lockup piston so that the first lockup piston and the second lockup piston are spaced away from each other in the axial direction. In this way, it is possible to connect the first and second lockup clutches in parallel with respect to the input and the output by engaging the two single-plate lockup clutches with the separate engagement surfaces (first engagement surface, second engagement surface) of the input. Thus, it is possible to improve torque capacity. It is also possible to suppress an increase in size of the input etc. in the radial direction since the first and second lockup clutches are disposed side by side in the axial direction. As a result, it is possible to suppress an increase in size of the device and improve torque capacity of the lockup clutch device.

### BRIEF DESCRIPTION OF THE DRAWINGS

FIG. 1 is a schematic diagram illustrating a structure of a fluid transmission device 10 of the disclosure.

FIG. 2 is a partially enlarged view of a first lockup clutch 60.

FIG. 3 is a partially enlarged view of a second lockup clutch 70.

### DETAILED DESCRIPTION OF EMBODIMENTS

Modes for carrying out the disclosure of the disclosure will be described below with reference to the drawings.

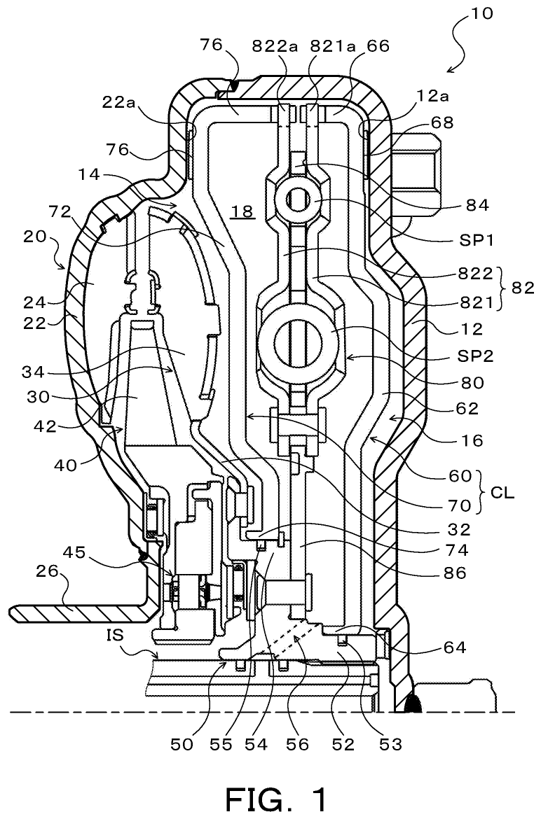

FIG. 1 is a schematic diagram illustrating a structure of a fluid transmission device 10 of the disclosure. The fluid transmission device 10 is installed in an automobile that has an engine (internal combustion engine) and an automatic transmission. As shown in FIG. 1, the fluid transmission device 10 has a front cover 12 that is coupled to a crankshaft of the engine, a pump impeller 20 that is fixed to the front cover 12, a turbine runner 30 that is disposed so as to face the pump impeller 20, a turbine hub 50 that serves as an output member fixed to an input shaft IS of the automatic transmission, a lockup clutch device CL, and a damper device 80 that is coupled to the turbine hub 50.

Here, in the following description, an “axial direction” indicates an extending direction of a central axis (axis) of the fluid transmission device 10, unless otherwise specified. A “radial direction” indicates an extending direction of a straight line extending from the central axis of the fluid transmission device 10 in a direction orthogonal to the central axis (radial direction), unless otherwise specified. A “circumferential direction” indicates a direction along a rotational direction of a rotary element of the fluid transmission device 10, unless otherwise specified.

As shown in FIG. 1, the pump impeller 20 includes: a pump shell 22 that is tightly fixed to the front cover 12, that forms an input member with the front cover 12, which receives an input of torque from the engine, and that defines a fluid chamber 14 in which hydraulic oil flows; and a plurality of pump blades 24 that are disposed on an inner surface of the pump shell 22. As shown in FIG. 1, the turbine runner 30 has a turbine shell 32 and a plurality of turbine blades 34 disposed on an inner surface of the turbine shell 32. An inner peripheral portion of the turbine shell 32 is fixed to the turbine hub 50 via a plurality of rivets. The pump impeller 20 and the turbine runner 30 face each other, and a stator 40 that adjusts the flow of working oil (working fluid) from the turbine runner 30 to the pump impeller 20 is coaxially placed between the pump impeller 20 and the turbine runner 30. The stator 40 has a plurality of stator blades 42, and a rotational direction of the stator 40 is set to only one direction by a one-way clutch 45. The pump impeller 20, the turbine runner 30, and the stator 40 form a torus (annular flow passage) that allows circulation of working oil. The fluid transmission device 10 functions as a torque converter that amplifies an input torque. In the fluid transmission device 10, the stator 40 and the one-way clutch 45 may be omitted and the pump impeller 20 and the turbine runner 30 may only function as a fluid coupling.

The lockup clutch device CL executes lockup in which the front cover 12, the pump shell 22, and the turbine hub 50 are coupled via the damper device 80. The lockup clutch device CL also executes lockup release in which the coupling is released. The lockup clutch device CL has a first lockup clutch 60 and a second lockup clutch 70.

The first lockup clutch 60 is a single-plate hydraulic clutch and has a first lockup piston 62 that is disposed inside the front cover 12 and the pump shell 22 (input member) and on the front cover 12 on the engine side, and that is fitted to the turbine hub 50 so as to be rotatable and movable in the axial direction.

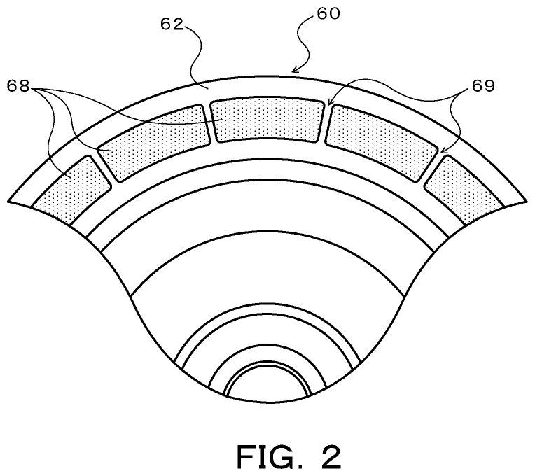

As shown in FIG. 2, a plurality of friction materials 68 are affixed at intervals in the circumferential direction on an outer peripheral portion of a surface of the first lockup piston 62 on the front cover 12 side. An oil passage 69 is formed between the adjacent friction materials 68 in the circumferential direction. The oil passages 69 are recessed with respect to a surface of each friction material 68 (friction engagement surface). Each oil passage 69 extends in the radial direction of the first lockup piston 62. To the first lockup piston 62, an annular friction material may be affixed instead of the friction materials 68. In this case, a plurality of oil passages (oil grooves) that are recessed with respect to the surface of the annular friction material may be disposed.

An annular first engagement surface 12a is formed on an inner wall surface of the front cover 12 that faces the friction materials 68, in parallel with the surfaces of the friction materials 68. The first lockup piston 62 is moved to the front cover 12 side in the axial direction so that the friction materials 68 are pushed against a first engagement surface 12a. Thus, the first lockup piston 62 is fictionally engaged with the front cover 12.

An inner tubular portion 64 that has a tubular shape and that extends to the opposite side of the first lockup piston 62 from the front cover 12 in the axial direction is formed on an inner peripheral portion of the first lockup piston 62. An outer tubular portion 66 that has a tubular shape and that extends to the opposite side of the first lockup piston 62 from the front cover 12 in the axial direction is formed on an outer peripheral portion of the first lockup piston 62. The inner tubular portion 64 is supported by a tubular first supporting portion 52 that is formed on an end portion of the turbine hub 50 on the front cover 12 side so that the inner tubular portion 64 is rotatable and movable in the axial direction. An annular seal mounting groove is formed on an outer peripheral surface of the first supporting portion 52. A space between the inner tubular portion 64 of the first lockup piston 62 and the first supporting portion 52 is sealed by a sealing member 53 that is disposed in the seal mounting groove.

The second lockup clutch 70 is a single-plate hydraulic clutch, is disposed inside the front cover 12 and the pump shell 22 (input member) and on the pump impeller 20 side, and has a second lockup piston 72 that is fitted to the turbine hub 50 so as to be rotatable and movable in the axial direction.

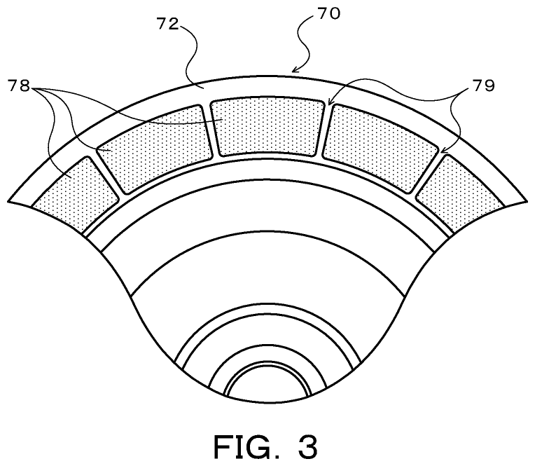

As shown in FIG. 3, a plurality of friction materials 78 are affixed at intervals in the circumferential direction on an outer peripheral portion of a surface of the second lockup piston 72 on the front cover 12 side. An oil passage 79 is formed between the adjacent friction materials 78 in the circumferential direction. The oil passages 79 are recessed with respect to a surface of each friction material 78 (friction engagement surface). Each oil passage 79 extends in the radial direction of the second lockup piston 72. Similar to the first lockup piston 62, an annular friction material may be affixed to the second lockup piston 72 instead of the friction materials 78. As shown in FIGS. 2 and 3, friction materials that have a larger area of a surface (friction engagement surface) than the friction materials 68 affixed to the first lockup piston 62 are adopted as the friction materials 78 affixed to the second lockup piston 72.

An annular second engagement surface 22a is formed on an inner surface of a side wall of the pump shell 22 that faces the friction materials 78, in parallel with the surfaces of the friction materials 78. The second lockup piston 72 is moved to the pump impeller 20 side in the axial direction (side opposite in the axial direction from the front cover 12) so that the surfaces of the friction materials 78 are pushed against the second engagement surface 22a. Thus, the second lockup piston 72 is frictionally engaged with the pump shell 22.

An inner tubular portion 74 that has a tubular shape and that extends to the opposite side of the second lockup piston 72 from the front cover 12 in the axial direction is formed on an inner peripheral portion of the second lockup piston 72. An outer tubular portion 76 that has a tubular shape and that extends in the axial direction on the front cover 12 side is formed, so as to face the outer tubular portion 66 of the first lockup piston 62. The inner tubular portion 74 is supported by a second supporting portion 54 that is formed radially outside the first supporting portion 52 of the turbine hub 50 and on a side away from the front cover 12 (turbine runner 30 side) so that the inner tubular portion 74 is rotatable and movable in the axial direction. An annular seal mounting groove is formed on an outer peripheral surface of the second supporting portion 54. A space between the inner tubular portion 74 of the second lockup piston 72 and the second supporting portion 54 is sealed by a sealing member 55 that is disposed in the seal mounting groove.

An oil chamber (oil space) 16 is defined between the first lockup piston 62 and the front cover 12 in the axial direction. An annular space is defined between an outer peripheral surfaces of the outer tubular portions 64, 74 of the first lockup piston 62 and the second lockup piston 72 and the inner surface of the front cover 12. A hydraulic control device not shown is connected to the oil chamber 16 via an oil passage formed in the input shaft IS and a clearance between the front cover 12 and the turbine hub 50. Working oil (circulation pressure) from the hydraulic control device is supplied to the oil chamber 16. Working oil supplied to the oil chamber 16 flows into the fluid chamber 14 via a clearance between the surfaces of the friction materials 68 and the inner surface (first engagement surface 12a) of the front cover 12 (during non-lockup) or the oil passages 69 between the adjacent friction materials 68 (during lockup), a space between the outer peripheral surfaces of the outer tubular portions 66, 76 and the inner surface of the front cover 12, or a clearance between the surfaces of the friction materials 78 and the inner surface (second engagement surface 22a) of the pump shell 22 (during non-lockup) or the oil passages 79 between the adjacent friction materials 78 (during lockup). Working oil that flows into the fluid chamber 14 flows out via an oil passage formed between a sleeve 26 of the pump impeller 20 and the one-way clutch 45.

An engagement oil chamber (oil space) 18 is defined between the first lockup piston 62 and the second lockup piston 72 in the axial direction. A supply oil passage 56 is formed in the turbine hub 50 so as to extend obliquely from an inner peripheral side to an outer peripheral side and communicate with the engagement oil chamber 18 between the first supporting portion 52 and the second supporting portion 54 in the axial direction. The supply oil passage 56 is connected to the hydraulic control device described above via the oil passage formed in the input shaft IS. Engagement hydraulic pressure (lockup pressure) that is regulated by the hydraulic control device to be higher than the circulation pressure described above is supplied to the engagement oil chamber 18 via the supply oil passage 56.

The damper device 80 is disposed between the first lockup piston 62 and the second lockup piston 72 in the axial direction, that is, inside the engagement oil chamber 18. The damper device 80 includes: a driving member (input element) 82, an intermediate member (intermediate element) 84, and a driven member (output element) 86, serving as rotary elements; and a plurality of outer springs SP1 disposed near an outer periphery of the damper device 80 and a plurality of inner springs SP2 disposed on an inner side with respect to the outer springs SP1, serving as torque transmitting elements (torque transmitting elastic bodies). The driven member 86 is coupled to the driving member 82 via the outer springs SP1, the intermediate member 84, and the inner springs SP2. The driven member 86 together with the turbine runner 30 is fixed (coupled) to the turbine hub 50 via a plurality of rivets.

The driving member 82 of the damper device 80 has an annular first drive plate 821 that is disposed on the front cover 21 side and an annular second drive plate 822 that is disposed on the turbine runner 30 side and that is coupled (fixed) to the first drive plate 821 via a plurality of rivets. An outer peripheral portion of the first drive plate 821 has a plurality of engagement protruded portions 821a that are each fitted in a corresponding one of engagement recessed portions formed on an end of the outer tubular portion 66 of the first lockup piston 62. An outer peripheral portion of the second drive plate 822 has a plurality of engagement protruded portions 822a that are each fitted in a corresponding one of engagement recessed portions formed on an end of the outer tubular portion 76 of the second lockup piston 72. Thus, the first drive plate 821 and the second drive plate 822, that is, the driving member 82, are coupled so as to be rotatable with the first lockup piston 62 and the second lockup piston 72.

In the fluid transmission device 10 formed in this way, the first lockup piston 62 and the second lockup piston 72 are disposed side by side in the axial direction and are supported so as to be movable in the axial direction, as described above. The engagement oil chamber 18 is defined by a space between the first lockup piston 62 and the second lockup piston 72 in the axial direction. Thus, the first lockup piston 62 and the second lockup piston 72 are moved so as to be spaced away from each other, when working oil (lockup pressure) is supplied to the engagement oil chamber 18. The friction materials 68 affixed to the first lockup piston 62 are pressed against the inner surface (first engagement surface 12a) of the front cover 12 that faces the friction materials 68, and the friction materials 78 affixed to the second lockup piston 72 are pressed against the inner surface (second engagement surface 22a) of the turbine shell 22 that faces the friction materials 78. Thus, the first lockup clutch 62 is frictionally engaged with the front cover 12 and the second lockup clutch 72 is frictionally engaged with the pump shell 22. In this way, the two single-plate hydraulic clutches are connected in parallel with respect to the front cover 12 and the pump shell 22 that serve as the input member and the turbine hub 50 (damper device 80) that serves as the outer member. Thus, it is possible to greatly improve torque capacity, compared to a case in which the input member and the output member are connected with one single-plate hydraulic clutch.

In the fluid transmission device 10, pressure in the fluid chamber 14 in the front cover 12 and the pump impeller 20 on the pump impeller 20 side becomes negative with the operation of the pump impeller 20 and the turbine runner 30. The second lockup piston 72 is more likely to be drawn to the pump impeller 20 side due to negative pressure generated in the fluid chamber 14. In the embodiment, since the second lockup piston 72 is more likely to be drawn to the pump impeller 20 side, responsiveness of the second lockup clutch 72 on the second lockup piston 72 side is improved. Negative pressure in the fluid chamber 14 increases as differential rotation between the pump impeller 20 and the turbine runner 30 increases. Thus, the second lockup piston 72 is more likely to be drawn to the pump impeller 20 side as the differential rotation increases. An improvement effect may be expected for NV performance, and controllability is improved.

As described above, the fluid transmission device of the disclosure is the fluid transmission device (10) including: the pump impeller (20) connected to the input member (12, 22); the turbine runner (30) disposed so as to face the pump impeller (20); the output member (50) coupled to the turbine runner (30); and the lockup clutch device (CL) configured to execute lockup in which the input member (12, 22) and the output member (50) are coupled and execute lockup release in which the coupling of the input member (12, 22) and the output member (50) is disconnected, the pump impeller (20), the turbine runner (30), the output member (50), and the lockup clutch (CL) being provided in the input member (12, 22). The input member (12, 22) has the first engagement surface (12a) and the second engagement surface (22a) that face each other with the lockup clutch device (CL) interposed between the first engagement surface (12a) and the second engagement surface (22a) in the axial direction. The lockup clutch device (CL) has the first lockup clutch (60) that includes the first lockup piston (62) in which the friction material (68) is affixed to the surface that faces the first engagement surface (12a), and the second lockup clutch (70) that includes the second lockup piston (72) in which the friction material (78) is affixed to the surface that faces the second engagement surface (22a). The lockup clutch device (CL) executes lockup by supplying working oil between the first lockup piston (62) and the second lockup piston (72) so that the first lockup piston (62) and the second lockup piston (72) are spaced away from each other in the axial direction.

The fluid transmission device of the disclosure includes the pump impeller, the turbine runner, the output member, and the lockup clutch device, which are provided in the input member. The input member has the first engagement surface and the second engagement surface that face each other with the lockup clutch device interposed between the first engagement surface and the second engagement surface in the axial direction. The lockup clutch device has the first lockup piston in which the friction material is affixed to the surface that faces the first engagement surface, and the second lockup piston in which the friction material is affixed to the surface that faces the second engagement surface. The lockup clutch device then performs lockup by supplying working oil between the first lockup piston and the second lockup piston so that the first lockup piston and the second lockup piston are spaced away from each other in the axial direction. In this way, it is possible to connect the first and second lockup clutches in parallel with respect to the input member and the output member by engaging the two single-plate lockup clutches with the separate engagement surfaces (first engagement surface, second engagement surface) of the input member. Thus, it is possible to improve torque capacity. It is also possible to suppress an increase in size of the input member etc. in the radial direction since the first and second lockup clutches are disposed side by side in the axial direction. As a result, it is possible to suppress an increase in size of the device and improve torque capacity of the lockup clutch device.

In the fluid transmission device of the disclosure, the first engagement surface (12a) may be formed on the side of the input member (12, 22) away from the pump impeller (20) and the turbine runner (30). The second engagement surface (22a) may be formed on the side of the input member (12, 22) closer to the pump impeller (20) side and the turbine runner (30). A surface area of the friction material (78) affixed to the second lockup piston (72) may be larger than a surface area of the friction material (68) affixed to the first lockup piston (62). Pressure in the fluid chamber in the input member on the pump impeller side becomes negative with the operation of the pump impeller and the turbine runner. The second lockup piston is more likely to be drawn to the pump impeller side due to negative pressure generated in the fluid chamber. Thus, the surface area of the friction material affixed to the second lockup piston is set to be larger than the surface area of the friction material affixed to the first lockup piston. It is therefore possible to use a drawing force, of which the second lockup piston is drawn to the pump impeller side, so as to further improve torque capacity.

The fluid transmission device of the disclosure may have the damper device (80) between the first lockup piston (62) and the second lockup piston (72) in the axial direction. The lockup clutch device (CL) may couple the input member (12, 22) and the output member (50) via the damper device (80). This makes it possible to further shorten an axial length of the fluid transmission device.

In the fluid transmission device of the disclosure, the second lockup piston (72) may be provided closer to the turbine runner (30) than the first lockup piston (62) and may be movable independently from the turbine runner (30). In general, in a torus portion defined by the pump impeller and the turbine runner, a flow velocity of the fluid is high and negative pressure that draws the turbine runner to the pump impeller side is generated. Therefore, when the second lockup piston is fixed to the turbine runner and moved with the turbine runner, controllability of the second lockup piston deteriorates due to negative pressure generated in the torus portion. Thus, by forming the second lockup piston independent of the turbine runner so as to be movable, it is possible to reduce the adverse effect on controllability of the second lockup piston caused by negative pressure generated in the torus portion, compared to the case in which the second lockup piston is integrally formed with the turbine runner. Since the first and second lockup clutches are disposed side by side in the axial direction, it is also possible to reduce the adverse effect on controllability of the first lockup piston.

The embodiments of the disclosure of the disclosure have been discussed above. However, the disclosure of the disclosure is not limited to the embodiments in any way, and it is a matter of course that the disclosure of the disclosure may be implemented in various modes without departing from the scope of the disclosure of the disclosure.

### INDUSTRIAL APPLICABILITY

The disclosure of the disclosure is applicable to the manufacturing industry of fluid transmission devices.

1. A fluid transmission device comprising:
a pump impeller connected to an input;
a turbine runner disposed so as to face the pump impeller;
an output coupled to the turbine runner; and
a lockup clutch device configured to execute lockup in which the input and the output are coupled and lockup release in which the coupling of the input and the output is disconnected,
the pump impeller, the turbine runner, the output, and the lockup clutch device being provided in the input, wherein
the input has a first engagement surface and a second engagement surface that face each other with the lockup clutch device interposed between the first engagement surface and the second engagement surface in an axial direction, and
the lockup clutch device has a first lockup clutch that includes a first lockup piston in which a friction material is affixed to a surface that faces the first engagement surface, and a second lockup clutch that includes a second lockup piston in which a friction material is affixed to a surface that faces the second engagement surface, and executes lockup by supplying working oil between the first lockup piston and the second lockup piston so that the first lockup piston and the second lockup piston are spaced away from each other in the axial direction.

2. The fluid transmission device according to claim 1, wherein
the first engagement surface is formed on a side of the input away from the pump impeller and the turbine runner,
the second engagement surface is formed on a side of the input closer to the pump impeller and the turbine runner, and
a surface area of the friction material affixed to the second lockup piston is larger than a surface area of the friction material affixed to the first lockup piston.

3. The fluid transmission device according to claim 1, wherein
a damper device is provided between the first lockup piston and the second lockup piston in the axial direction, and
the lockup clutch device couples the input and the output via the damper device.

4. The fluid transmission device according to claim 1, wherein the second lockup piston is provided closer to the turbine runner than the first lockup piston and is movable independently from the turbine runner.
